(19) United States
(12) Patent Application Publication
(10) Pub. No.: US 2024/0194883 A1
(43) Pub. Date: Jun. 13, 2024

(54) ASSB Cathode Having Controlled Electronic Conductive Paths

(71) Applicant: Nissan North America, Inc., Franklin, TN (US)

(72) Inventors: Naoki Ueda, Farmington Hills, MI (US); Somayeh Zamani, Novi, MI (US); Bharat Gattu, Farmington, MI (US)

(21) Appl. No.: 18/065,435

(22) Filed: Dec. 13, 2022

(51) Int. Cl. H01M 4/62; H01M 10/0525

(52) U.S. Cl. CPC H01M 4/625; H01M 4/628; H01M 10/0525

(57) ABSTRACT

A cathode composite layer for an ASSB cell comprises cathode active material, a solid electrolyte, and conductive pathways. Each conductive pathway comprises a cylindrical carbon nanostructure having a first end and a second end with an exterior wall extending between the first end and the second end, and an insulating sheath covering the cylindrical carbon nanostructure except in an uncovered portion of the cylindrical carbon nanostructure, the uncovered portion being the first end and a first portion of the exterior wall directly adjacent the first end and the second end and a second portion of the exterior wall directly adjacent the second end.

### TECHNICAL FIELD

This disclosure relates to cathodes for all-solid-state batteries, the cathode active material layer being a composite layer designed to promote electronic conductivity while suppressing solid electrolyte decomposition with the incorporation of controlled electronic conductive paths.

### BACKGROUND

Advances have been made toward high energy density batteries, using lithium metal as the anode material, and solid electrolytes to form all-solid-state batteries (ASSBs). Discovery of new materials and the relationship between their structure, composition, properties, and performance have advanced the field. However, even with these advances, batteries remain limited by the underlying choice of materials and electrochemistry.

Among the impediments to the practical application of ASSBs are the reactions occurring at the interface between the cathode's carbon additive and the solid electrolyte. There is a need to improve the interface between the solid electrolyte and the carbon material, maintaining sufficient electronic conductivity through the cathode while minimizing the solid electrolyte electrochemical decomposition.

### SUMMARY

Disclosed herein are implementations of a composite cathode material for an ASSB cell. In an implementation, a cathode composite layer for an ASSB cell comprises cathode active material, a solid electrolyte, and conductive pathways. Each conductive pathway comprises a cylindrical carbon nanostructure having a first end and a second end with an exterior wall extending between the first end and the second end, and an insulating sheath covering the cylindrical carbon nanostructure except in an uncovered portion of the cylindrical carbon nanostructure, the uncovered portion being the first end and a first portion of the exterior wall directly adjacent the first end and the second end and a second portion of the exterior wall directly adjacent the second end.

Also disclosed herein are implementations of ASSB cells and ASSBs having an anode comprising lithium metal, a solid electrolyte, and a cathode composite layer as disclosed herein. An implementation of an ASSB cell comprises an anode comprising lithium metal, a solid electrolyte layer, a cathode current collector, and a cathode composite layer between the cathode current collector and the solid electrolyte layer. The cathode composite layer comprises cathode active material, cathode layer solid electrolyte, and conductive pathways. Each conductive pathway comprises a cylindrical carbon nanostructure and an insulating sheath covering the cylindrical carbon nanostructure.

Variations in these and other aspects, features, elements, implementations, and embodiments disclosed herein are described in further detail hereafter.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic of a cathode of an ASSB cell having a cathode composite layer on a cathode current collector.

FIG. 2A is a cross-section of an implementation of a conductive pathway as disclosed herein.

FIG. 2B is a plan view of the conductive pathway of FIG. 2A.

FIG. 3 is a cross-section of another implementation of a conductive pathway as disclosed herein.

FIG. 4 is a schematic of another cathode of an ASSB cell having a cathode composite layer on a cathode current collector.

FIG. 5 is a cross-section of another implementation of a conductive pathway as disclosed herein.

FIG. 6 is a cross-section of yet another implementation of a conductive pathway as disclosed herein.

FIG. 7 is a schematic of a cross-section of an ASSB cell.

### DETAILED DESCRIPTION

Advances have been made toward high energy density batteries, including both lithium metal and lithium-ion batteries. However, these advances are limited by the underlying choice of materials and electrochemistry. Traditional lithium-ion batteries either use organic liquid electrolytes, prone to negative reactions with active materials, or ionic liquid electrolytes, with increased viscosities and lower ionic conductivity. ASSBs can address some or all of these issues, as well as produce higher energy densities. However, the large interfacial resistance at the electrolyte/electrode interface and the interfacial stability and compatibility due to reactivity affect the electrochemical performance of ASSBs.

For ASSBs, electrode materials are those that reversibly insert ions through ion-conductive, crystalline materials. Conventional cathode active material consists of a transition metal oxide with the formula LiMOₓ, where M is one or more transition metals, which undergoes low-volume expansion and contraction during lithiation and delithiation. The anode active material can be lithium metal, the low density of lithium metal producing a much higher specific capacity than traditional graphite anode active material.

While solid electrolytes show promise with the lithium metal anodes, and solid electrolytes have been developed with high ionic conductivities, the chemical, electrochemical and mechanical stabilities at the solid-solid interfaces present challenges. In particular, sulfide-based solid electrolytes have relatively poor intrinsic chemical and electrochemical stabilities against traditional cathode materials, including the carbon additives.

In ASSBs, the cathode layer should have both high electronic conductivity and high ionic conductivity. Carbon additives are incorporated into the cathode active material to increase the electronic conductivity, while solid electrolytes are added to the cathode active material to increase the ionic conductivity. Typically, solid electrolytes, and in particular sulfide-based solid electrolytes, are highly ionically conductive but are not very electrochemically stable. During charging of the ASSB, carbon can accelerate the electrochemical decomposition of the solid electrolyte, causing capacity fade and increased resistance. Using carbon additives that have less surface area to reduce contact points between the carbon and the solid electrolyte has been found to have little impact, as the decomposition of the solid electrolyte still occurs at the carbon/solid electrolyte interface, particularly toward the cathode current collector side of the cathode active material layer.

Disclosed herein is a cathode composite layer for an ASSB cell that includes cathode active material, a solid electrolyte, and conductive pathways. Each conductive pathway is a cylindrical carbon nanostructure having an insulating sheath covering the cylindrical carbon nanostructure on a major part of the carbon surface. Ends of the carbon nanostructure remain uncovered, providing an entrance and exit for electronic conduction between cathode active material particles throughout the cathode composite layer. The insulating sheath prevents direct contact between the major surfaces of the carbon nanostructure and the solid electrolyte, reducing the electrochemical decomposition of the solid electrolyte.

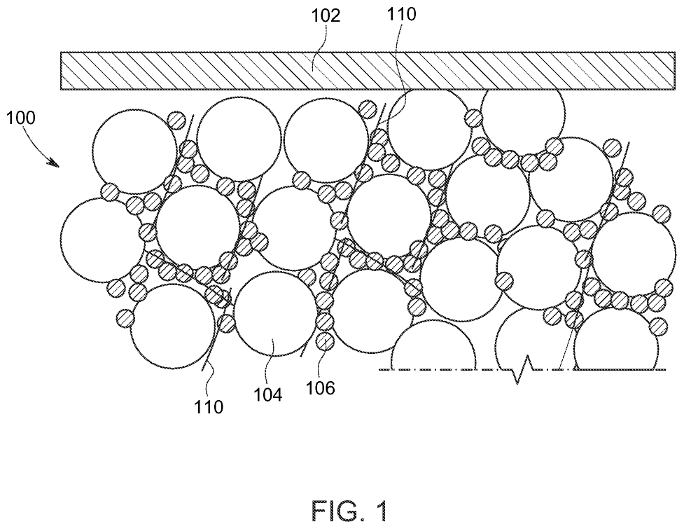

A cathode composite layer 100 for an ASSB cell is shown schematically in FIG. 1. The cathode composite layer 100 is shown with a cathode current collector 102 and comprises cathode active material 104, a solid electrolyte 106, and conductive pathways 110.

The cathode active material 104 can include one or more lithium transition metal oxides and lithium transition metal phosphates which can be bonded together using binders and optionally conductive fillers such as carbon black. Lithium transition metal oxides and lithium transition metal phosphates can include, but are not limited to, LiCoO₂, LiNiO₂, LiNi_{0.8}Co_{0.15}Al_{0.05}O₂, LiMnO₂, Li(Ni_{0.5}Mn_{0.5})O₂, LiNiₓCo_{y}Mn₂O₂, spinel Li₂Mn₂O₄, LiFePO₄ and other polyanion compounds, and other olivine structures including LiMnPO₄, LiCoPO₄, LiNi_{0.5}Co_{0.5}PO₄, and LiMn_{0.33}Fe_{0.33}Co_{0.33}PO₄. The cathode active material can be a sulfur-based active material and can include LiSO₂, LiSO₂Cl₂, LiSOCl₂, and LiFeS₂, as non-limiting examples.

The solid electrolyte 106, also referred to as the cathode solid electrolyte to differentiate it from the solid electrolyte layer in the ASSB cell, can be, as non-limiting examples, sulfide compounds (e.g. Argyrodite-type such as Li₆PS₅Cl, LGPS, LPS, etc.), garnet structure oxides (e.g. LLZO with various dopants), NASICON-type phosphate glass ceramics (LAGP), oxynitrides (e.g. lithium phosphorus oxynitride or LIPON), and polymers (PEO). The cathode solid electrolyte 106 can be the same solid electrolyte material that is used in the ASSB's solid electrolyte layer or can be a different solid electrolyte material.

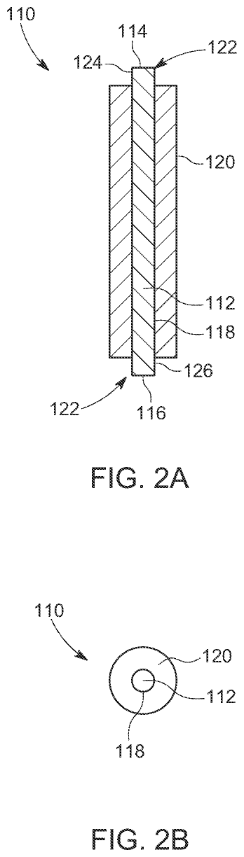

Embodiments of conductive pathways are described herein with reference to the figures. As shown in FIG. 2A, a cross-sectional view of the conductive pathway 110, and FIG. 2B, a plan view of the conductive pathway 110, each conductive pathway 110 is formed of a cylindrical carbon nanostructure 112 having a first end 114 and a second end 116 with an exterior wall 118 extending between the first end 114 and the second end 116. An insulating sheath 120 covers the cylindrical carbon nanostructure 112 except in an uncovered portion 122 of the cylindrical carbon nanostructure 112, the uncovered portion 122 being the first end 114 and a first portion 124 of the exterior wall 118 directly adjacent the first end 114 and the second end 116 and a second portion 126 of the exterior wall 118 directly adjacent the second end 116.

The cylindrical carbon nanostructures disclosed herein can be carbon fiber, carbon nanotubes, carbon nano-helices, or other similar carbon nanostructures suitable as a carbon additive in an ASSB cell.

The insulating sheath 120 should be stable to cathode potential, mechanically flexible and electronically insulating. The insulating sheath can be formed from a glass or insulating polymer such as polytetrafluoroethylene (PTFE). Other appropriate materials from which the material can be selected include aluminum oxide (Al₂O₃), magnesium oxide (MgO), lithium carbonate (Li₂CO₃), (Li₂O—Li₃PO₄)CaO, calcium carbonate (CaCO₃), silicon oxide (SiO), silicon dioxide (SiO₂), aluminum silicate (AlₓSi_{y}O_{z}), zirconium dioxide (ZrO), zinc oxide (ZnO), titanium oxide (TiO), titanium dioxide (TiO₂), and zinc sulfide (ZnS).

The thickness of the insulating sheath 120 can be between about 10 nm and 20 nm. Each uncovered portion 122 of the cylindrical carbon nanostructure 112 is between 3%-6% of a total surface area of the cylindrical carbon nanostructure 112. Described another way, the exterior wall 118 of the cylindrical carbon nanostructure 112 is between about 88% to 94% covered, with the surface area of the ends being negligible.

The conductive pathways 110 can be mixed into the cathode composite layer 100 as illustrated in FIG. 1, providing electron conduction through the cathode composite layer while significantly reducing the interface between the carbon and the solid electrolyte. The carbon nanostructures can be about 1.0 wt % to 5.0 wt % of the cathode composite layer 100. Alternatively, the conductive pathways 110 can be aligned vertically, or parallel to a stacking or thickness direction of the ASSB cell, preferably with one of the first end 114 or second end 116 in contact with the cathode current collector 102. The vertical alignment can further promote electron conduction along the entire thickness of the cathode composite layer 100. The vertical alignment can be achieved using an electric field, for example. The conductive pathways 110 can be uniformly spaces when aligned vertically to provide more uniform electron conduction.

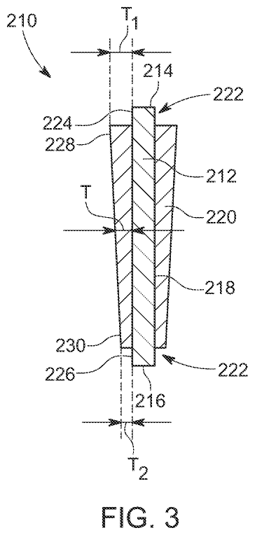

FIG. 3 is another implementation of a conductive pathway 210. FIG. 3 is a cross-sectional view of the conductive pathway 210 formed of a cylindrical carbon nanostructure 212 having a first end 214 and a second end 216 with an exterior wall 218 extending between the first end 214 and the second end 216. An insulating sheath 220 covers the cylindrical carbon nanostructure 212 except in uncovered portions 222 of the cylindrical carbon nanostructure 212, the uncovered portions 222 being the first end 214 and a first portion 224 of the exterior wall 218 directly adjacent the first end 214 and the second end 216 and a second portion 226 of the exterior wall 218 directly adjacent the second end 216.

Each uncovered portion 222 of the cylindrical carbon nanostructure 212 is between 3%-6% of a total surface area of the cylindrical carbon nanostructure 212. Described another way, the exterior wall 218 of the cylindrical carbon nanostructure 212 is between about 88% to 94% covered, with the surface area of the ends being negligible.

The insulating sheath 220 extends between a first coating end 228 proximate the first end 214 of the cylindrical carbon nanostructure 212 and a second coating end 230 proximate the second end 216 of the cylindrical carbon nanostructure 212, the first coating end 228 having a first thickness T1 that is greater than a second thickness T2 of the second coating end 230, a thickness T of the insulating sheath 220 gradually decreasing from the first thickness T1 at the first coating end 228 to the second thickness T2 at the second coating end 230. The first thickness T1 is 100 nm or less and the second thickness T2 is 5 nm or more, so long as the thickness T of the insulating sheath 220 gradually decreases from the first thickness T1 to the second thickness T2.

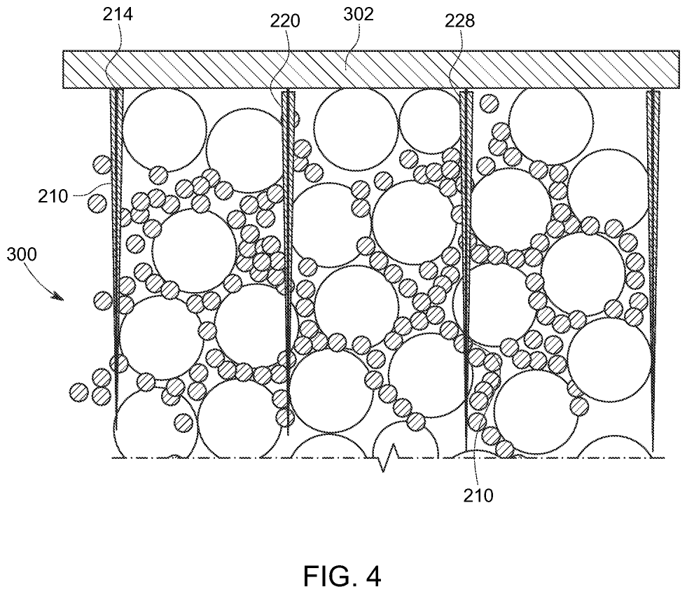

As illustrated in the cathode composite layer 300 of the ASSB cell of FIG. 4, the conductive pathways 210 can be aligned vertically, or parallel to a stacking direction of the ASSB cell, preferably with the end having the thickest insulating sheath portion, here first end 214 first coating end 228, in contact with the cathode current collector 302. The vertical alignment can further promote electron conduction along the entire thickness of the cathode composite layer 300. The vertical alignment can be achieved using an electric field, for example. The conductive pathways 210 can be uniformly spaces when aligned vertically to provide more uniform electron conduction. The conductive pathway 210 is aligned so that the thickest part of the insulated sheath 220 is nearest the cathode current collector 302 and the thinnest part of the insulated sheath 220 is furthest from the cathode current collector 302. The thicker part of the insulating sheath 220 is used in an area of greatest electrochemical instability, with the thicker insulating sheath 220 providing electrochemical stability. The thinner part of the insulating sheath 220 is provided in a more electrochemically stable environment (not near the cathode current collector 302) and so can provide more electron conduction.

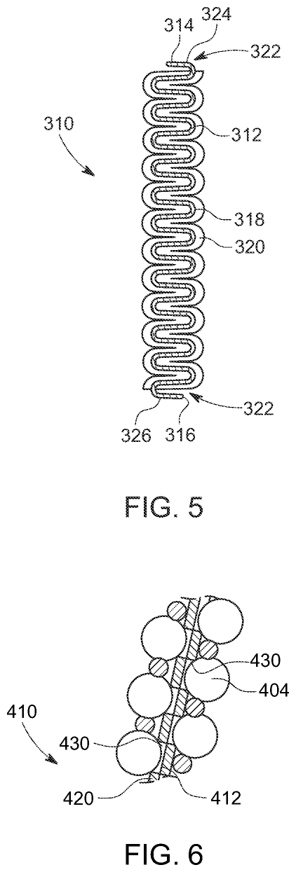

FIG. 5 is another implementation of a conductive pathway 310. FIG. 5 is a cross-sectional view of the conductive pathway 310 formed of a carbon nano-helix 312 as the cylindrical carbon nanostructure having a first end 314 and a second end 316 with an exterior wall 318 extending between the first end 314 and the second end 316. An insulating sheath 320 covers the carbon nano-helix 312 except in uncovered portions 322 of the carbon nano-helix 312, the uncovered portions 322 being the first end 314 and a first portion 324 of the exterior wall 318 directly adjacent the first end 314 and the second end 316 and a second portion 326 of the exterior wall 318 directly adjacent the second end 316.

The conductive pathway 310 using the carbon nano-helix 312 can also be positioned vertically, or parallel to a stacking direction of the ASSB cell, preferably with one of the first end 314 or second end 316 in contact with the cathode current collector. The vertical alignment can further promote electron conduction along the entire thickness of the cathode composite layer. The vertical alignment can be achieved using an electric field, for example. The conductive pathways 310 can be uniformly spaces when aligned vertically to provide more uniform electron conduction. The ASSB cell can undergo volume changes during charging and discharging. This change of volume, and by extension, thickness, of the cell as lithium moves between the anode and the cathode, can cause mechanical degradation of the cell. Because the carbon nano-helix 312 inherently has a flexible length, like a coil, the conductive pathway 310 can better withstand the mechanical forces due to volume changes due to charge/discharge.

FIG. 6 is another implementation of a conductive pathway 410. FIG. 6 similar to the conductive pathway 110 but the insulating sheath 420 has additional uncovered areas 430 between the uncovered portions (not shown). These additional uncovered areas 430, in which the cylindrical carbon nanostructure 412 is exposed, is aligned with a cathode active material particle 404. The size of each additional uncovered area 430 would depend on a size of the cathode active material particle 404. The alignment between the additional uncovered areas 430 and the cathode active material particles 404 may be achieved, as a non-limiting example, by patterning a functional group surface modification on the cathode active material particles 404 that increases their affinity to the carbon nanostructure. The conductive pathways 410 can be either randomly or vertically aligned in the cathode composite layer as with conductive pathways 110.

The conductive pathways disclosed herein can be made using, for example, electrospinning, wet spinning, or plasma enhance chemical vapor deposition.

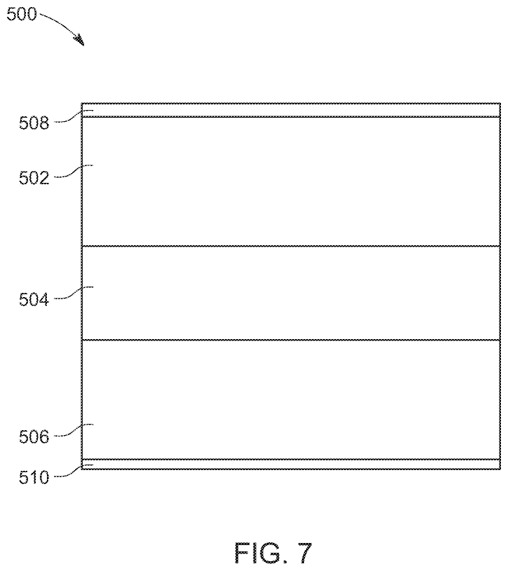

Also disclosed are ASSB cells incorporating the cathode composite layers with the conductive pathways as disclosed herein. An ASSB cell 500 is illustrated schematically in cross-section in FIG. 7. The ASSB cell 500 of FIG. 7 is configured as a layered battery cell that includes as active layers a cathode composite layer 502 as described herein, a solid electrolyte 504, and an anode active material layer 506. In addition to the active layers, the ASSB cell 500 of FIG. 7 may include a cathode current collector 508 (such as cathode current collector 102 and 302) and an anode current collector 510, configured such that the active layers are interposed between the anode current collector 510 and the cathode current collector 508. In such a configuration, the cathode current collector 508 is adjacent to the cathode composite layer 502, and the anode current collector 510 is adjacent to the anode active material layer 506. An ASSB can be comprised of multiple ASSB cells 500.

The anode active material in the anode active material layer 506 can be a layer of elemental lithium metal, a layer of a lithium compound(s) or a layer of doped lithium. The anode current collector 510 can be, as a non-limiting example, a sheet or foil of copper, nickel, a copper-nickel alloy, carbon paper, or graphene paper.

The solid electrolyte 504 can be, as non-limiting examples, sulfide compounds (e.g. Argyrodite-type such as Li₆PS₅Cl, LGPS, LPS, etc.), garnet structure oxides (e.g. LLZO with various dopants), NASICON-type phosphate glass ceramics (LAGP), oxynitrides (e.g. lithium phosphorus oxynitride or LIPON), and polymers (PEO). The solid electrolyte 504 can be the same solid electrolyte material 106 that is used in the cathode composite layers 100, 300 or can be a different solid electrolyte material.

The cathode current collector 508 can be, as a non-limiting example, an aluminum sheet or foil, carbon paper or graphene paper.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An all-solid-state battery (ASSB) cell, comprising:
an anode comprising lithium metal;
a solid electrolyte layer;
a cathode current collector; and
a cathode composite layer between the cathode current collector and the solid electrolyte layer, the cathode composite layer comprising:
cathode active material;
cathode layer solid electrolyte; and
conductive pathways, a conductive pathway comprising:
a cylindrical carbon nanostructure; and
an insulating sheath covering the cylindrical carbon nanostructure.

2. The ASSB cell of claim 1, wherein the cathode layer solid electrolyte is a sulfide-based electrolyte.

3. The ASSB cell of claim 1, wherein the cylindrical carbon nanostructure has a first end and a second end with an exterior wall extending between the first end and the second end, the conductive pathway further comprising:
an uncovered portion of the cylindrical carbon nanostructure, the uncovered portion being the first end and a first portion of the exterior wall directly adjacent the first end and the second end and a second portion of the exterior wall directly adjacent the second end.

4. The ASSB cell of claim 3, wherein the uncovered portion is between 3%-6% of a surface area of the cylindrical carbon nanostructure.

5. The ASSB cell of claim 3, wherein the conductive pathway is aligned in the cathode composite layer to be parallel to a stacking direction of the ASSB cell, with the first end in contact with the cathode current collector.

6. The ASSB cell of claim 5, wherein the insulating sheath extends between a first coating end proximate the first end of the cylindrical carbon nanostructure and a second coating end proximate the second end of the cylindrical carbon nanostructure, the first coating end having a first thickness that is greater than a second thickness of the second coating end, a thickness of the insulating sheath gradually decreasing from the first thickness at the first coating end to the second thickness at the second coating end.

7. The ASSB cell of claim 6, wherein the first thickness is 100 nm or less and the second thickness is 5 nm or more.

8. The ASSB cell of claim 1, wherein the conductive pathway is aligned in the cathode composite layer to be parallel to a stacking direction of the ASSB cell, with one end in contact with the cathode current collector.

9. The ASSB cell of claim 8, wherein the cylindrical carbon nanostructure is a carbon nano-helix.

10. The ASSB cell of claim 1, wherein the insulating sheath has a thickness of between 10 nm and 20 nm.

11. The ASSB cell of claim 1, wherein the cylindrical carbon nanostructure is one of a carbon fiber or a carbon nanotube.

12. The ASSB cell of claim 1, wherein the insulating sheath is a material selected from the group consisting of Al₂O₃, MgO, Li₂CO₃, (Li₂O—Li₃PO₄)CaO, CaCO₃, SiO, SiO₂, AlₓSi_{y}O_{z}, ZrO, ZnO, TiO, TiO₂, ZnS, and polytetrafluoroethylene (PTFE).

13. A cathode composite layer for an ASSB cell, comprising:
cathode active material;
a solid electrolyte; and
conductive pathways, wherein a conductive pathway comprises:
a cylindrical carbon nanostructure having a first end and a second end with an exterior wall extending between the first end and the second end; and
an insulating sheath covering the cylindrical carbon nanostructure except in an uncovered portion of the cylindrical carbon nanostructure, the uncovered portion being the first end and a first portion of the exterior wall directly adjacent the first end and the second end and a second portion of the exterior wall directly adjacent the second end.

14. The cathode composite layer of claim 13, wherein the uncovered portion is between 3%-6% of a surface area of the cylindrical carbon nanostructure.

15. The cathode composite layer of claim 13, wherein the conductive pathway is aligned in the cathode composite layer to be parallel to a thickness direction of the cathode composite layer.

16. The cathode composite layer of claim 15, wherein the insulating sheath extends between a first coating end proximate the first end of the cylindrical carbon nanostructure and a second coating end proximate the second end of the cylindrical carbon nanostructure, the first coating end having a first thickness that is greater than a second thickness of the second end, a thickness of the insulating sheath gradually decreasing from the first thickness at the first coating end to the second thickness at the second coating end.

17. The cathode composite layer of claim 16, wherein the first thickness is 100 nm or less and the second thickness is 5 nm or more.

18. The cathode composite layer of claim 15, wherein the cylindrical carbon nanostructure is a carbon nano-helix.

19. The cathode composite layer of claim 13, wherein the cylindrical carbon nanostructure is one of a carbon fiber or a carbon nanotube.

20. The cathode composite layer of claim 13, wherein the conductive pathway has additional uncovered areas between the uncovered portions, each additional uncovered area aligned with a particle of the cathode active material.
